(19) United States
(12) Patent Application Publication
(10) Pub. No.: US 2007/0139042 A1
(43) Pub. Date: Jun. 21, 2007

(54) MAGNETIC POSITION SENSOR WITH OPTIMIZED DETECTION

(75) Inventor: Bertrand LEGRAND, Grenoble (FR)

Correspondence Address: DENNISON, SCHULTZ & MACDONALD, 1727 KING STREET, SUITE 105, ALEXANDRIA, VA, 22314, US

(73) Assignee: ELECTRICFIL AUTOMOTIVE, Miribel (FR)

(21) Appl. No.: 11/611,993

(22) Filed: Dec. 18, 2006

(30) Foreign Application Priority Data
Dec. 20, 2005 (FR) 05 12 927

(51) Int. Cl. G01B 7/30

(52) U.S. Cl. 324/207.25

(57) ABSTRACT

The invention concerns a position sensor in which the irregular pole includes resources for correcting the value of its magnetic field so as to stabilize the differential signal in such a way that the part of the differential signal taken at the passage through zero, and located between the parts of the differential signal corresponding to the passages of the adjacent poles, has a slope whose value, in absolute terms, is more-or-less identical to the values of the slopes of the parts of the differential signal obtained at the passage through zero and corresponding to the passages of the other poles.

### BACKGROUND OF THE INVENTION

This present invention concerns the technical area of magnetic sensors that include a coder element moving close to at least one detection cell and designed to determine at least one angular position in the general sense. Most particularly, the subject of the invention concerns the creation of a sensor whose coder is equipped with a series of north and south poles mounted alternately.

The subject of the invention finds a particularly advantageous application in the motor-vehicle area, where this sensor can be used, for example, in the context of ignition functions.

In the aforementioned preferred area, the practice of employing a magnetic sensor designed to measure changes in the strength of a magnetic field when a magnetic coder passes in front of a detection cell, is already known. Such a coder is composed of a multi-pole magnetic ring that is equipped around its circumference with alternate and regularly-spaced north and south poles on a given pitch. The regular north and south poles are normally high in number, in order that such a speed sensor will have good resolution.

The detection cell, which can be a Hall-effect probe for example, delivers a periodic sinusoidal signal. The detection cell is associated with a hysteresis level comparator, which can be a Schmitt trigger, used to obtain sharp transitions of the output voltage, so providing distinct values of the magnetic induction, according to whether it is varying upward or downward. In order to be able to determine at least one position, corresponding to the top dead centre of the ignition of a cylinder for example, one can envisage either removing several magnetic poles and so leaving an empty space, or replacing one or more poles of a given polarity by one or more poles of the opposite polarity. The result is known as an irregular pole, presenting, firstly, magnetization whose polarity is opposite to the polarities of its two adjacent poles and, secondly, a different separation in relation to the separation pitch of the other poles.

In order to obtain good measurement accuracy, in particular regarding detection of the irregular pole, patent FR 2 757 943 describes the creation of a coder that includes, for each irregular pole, resources for correcting the value of the magnetic field created by the irregular pole so that the signal delivered by the passage of the poles in the vicinity of the said irregular poles should be symmetrical in relation to the zero value of the magnetic field.

The use of such a coder allows a magnetic signal to be obtained at the output from the detection cell of the sensor, whose period is constant in the case of the regular poles. This results in good accuracy of the measurements effected in this way, in particular for identifying the irregular pole.

Consideration has been given to improving the coding of the position or speed of the coder associated with the ignition functions of a motor vehicle. In order to attain this objective, it has been proposed that the intermediate edge of the differential signal, located between the edges obtained from the differential signal corresponding to the passage from the adjacent poles to the irregular poles, should be used.

### SUMMARY OF THE INVENTION

One aim of the invention is therefore to propose a position sensor that has an increased coding option in relation to the sensors of previous design, while also exhibiting good accuracy of the measurements performed, in particular in relation to the irregular pole, with an improved coding capability.

In order to attain such an objective, the position sensor is of the type that has a coder formed by a multi-pole magnetic ring which is equipped around its circumference with alternate north and south poles and mounted to rotate in front of at least one pair of measuring elements, each delivering a periodic signal which firstly corresponds to changes in the strength of the magnetic field delivered by the poles, and secondly is used to obtain a differential signal between the said two signals, where at least one of the poles of the opposite polarity to the polarity of its adjacent poles is said to be irregular and has a different separation between its two adjacent poles in relation to the separation pitch between the other poles.

According to the invention, the irregular pole includes resources for correcting the value of its magnetic field, so as to stabilize the differential signal in such a way that the part of the differential signal obtained at the passage through zero, and located between the parts of the differential signal corresponding to the passages of the adjacent poles, has a slope whose value, in absolute terms, is more-or-less identical to the values of the slopes of the parts of the differential signal obtained at the passage through zero and corresponding to the passages of the other poles.

According to one implementation characteristic, the resources for correcting the value of the magnetic field of the irregular pole are designed, in more-or-less identical manner, to stabilize the rising (leading) or falling (trailing) edge obtained from the differential signal located between the falling or rising edges respectively obtained from the differential signal, and corresponding to the passage from the adjacent poles to the irregular pole.

According to another implementation characteristic, the resources for correcting the value of the magnetic field of the irregular pole are designed, in more-or-less identical fashion, to stabilize the rising or falling edge obtained from the differential signal located between the falling or rising edges respectively obtained from the differential signal, and corresponding to the passage of all the north and south poles.

For example, the resources for correcting the value of the magnetic field of the irregular pole are such that the slopes at the passage through zero, firstly of the part of the differential signal located between the parts of the differential signal corresponding to the passages of the adjacent poles, and secondly of the parts of the differential signal corresponding to the passages of the adjacent poles and of the other poles, have a value that is more-or-less identical and greater than 30 gauss per degree, and preferably greater than 100 gauss per degree.

According to one implementation example, the resources for correcting the value of the magnetic field of the irregular pole take the form of a gradual magnetization, such that the raw signal obtained from the passage of the irregular pole in front of a measuring element varies symmetrically. Advantageously, the raw signal, obtained from the passage of the irregular pole, has a rising part and a falling part, separated by a linking part whose width is at least greater than the distance taken at the level of the measuring radius between the measuring elements. Preferably the linking part of the raw signal has a shape that is identical to the parts of the raw signal corresponding to the regular poles.

According to one implementation variant, the gradual magnetization of the irregular pole has a profile of which at least one part is the arc of a curve.

According to another implementation variant, the gradual magnetization of the irregular pole has a profile with one part in the arc of a curve, bordered on either side by a magnetic gap part.

According to another implementation variant, the gradual magnetization of the irregular pole has a profile with one part in the arc of a curve, bordered on either side by poles of opposite polarity. According to one preferred application, the coder is fixed in rotation on a rotating shaft of a motor vehicle.

The coder is mounted on a shaft of a motor-vehicle engine for example.

Advantageously, the coder is mounted on a transmission shaft of a motor vehicle.

### BRIEF DESCRIPTION OF THE DRAWINGS

Diverse other characteristics will emerge from the description that follows, and given with reference to the appended drawings which, by way of non-limiting examples, show forms of implementation of the subject of the invention.

FIG. 1 is a schematic view in perspective showing one implementation example of a position sensor according to the invention.

FIG. 2 is a view, opened out into a plane, of one implementation example of a coder according to the invention.

FIGS. 3A and 3B illustrate changes in the magnetic induction obtained during the movement of a coder, respectively deprived of and equipped with the correction resources according to the invention.

FIGS. 4A and 4B illustrate changes in the differential signal obtained during the movement of a coder, respectively deprived of or equipped with the correction resources according to the invention.

FIG. 5 is a timing diagram, obtained during the movement of a coder, whether equipped or not with the correction resources according to the invention.

FIGS. 6 to 8 illustrate implementation examples of magnetization profiles using the correction resources according to the invention.

### DESCRIPTION OF THE PREFERRED EMBODIMENTS

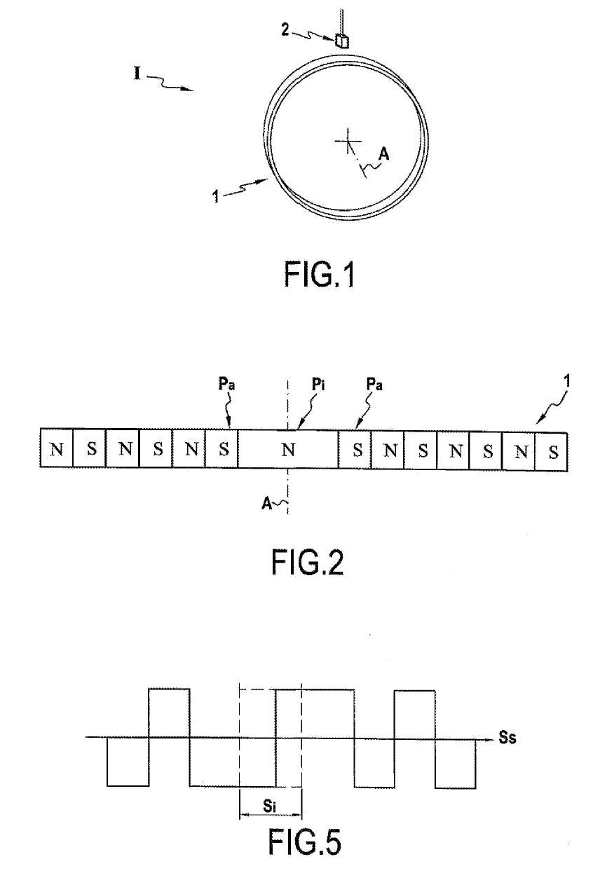

FIG. 1 and 2 show one implementation example of a magnetic position sensor 1 that includes a magnetic coder 1 mounted to pass in front of at least one pair of measuring or detection elements 2, to constitute a detection cell. The coder 1 is created in the form of a multi-pole magnetic ring, driven in rotation about its centre on axis A, and that is equipped around its circumference with alternate north poles N and south poles S, with radial magnetization. As an example, the coder 1 is composed of a crown forming a support onto which a ring is affixed, the latter being made of an elastomer material which is loaded with magnetized particles to constitute north and south poles.

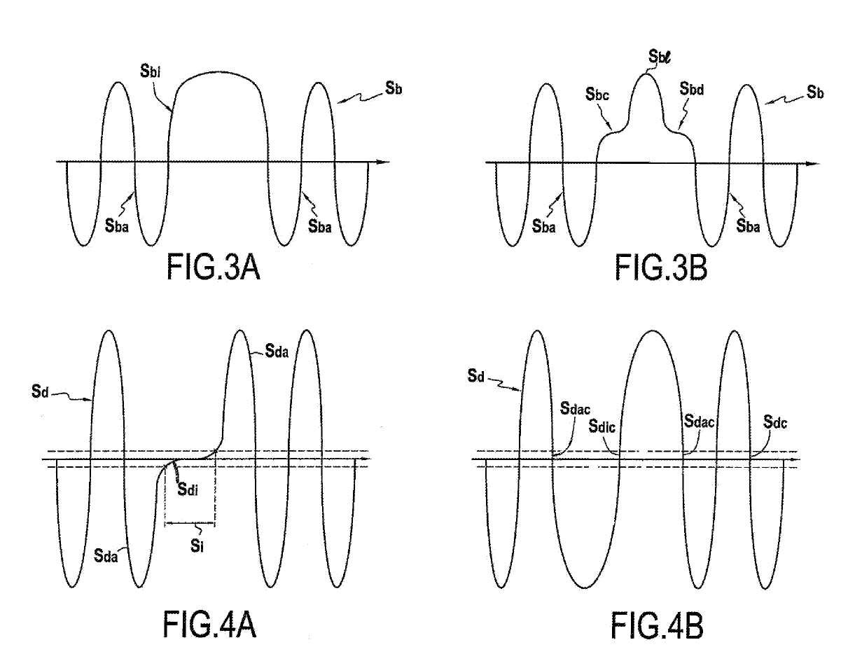

Each measuring element 2 generates a periodic signal (Sb in FIGS. 3A, 3B) corresponding to changes in the strength of the magnetic field delivered by the poles moving in front of it. This detection cell can be a Hall-effect cell for example, with differential Hall effect or Hall effect with flux concentration, or even a magneto-resistive cell or a giant magnetoresistive cell (GMR). The detection elements 2 are connected to processing resources (not shown but known as such) which are used to obtain a differential signal Sd, obtained by taking the difference between the signals Sb delivered by the detection elements 2 (see FIGS. 4A, 4B).

In the example illustrated, the coder 1 includes a series of south poles S and north poles N, arranged to have a regular separation pitch between two adjacent poles. The angular width of each pole can be 3° for example. As can be seen in greater detail in FIG. 2, the coder 1 also includes at least one irregular or singular pole Pi that has a different separation between its two adjacent poles Pa in relation to the regular separation pitch between the south S and north N poles. In the example illustrated, the irregular pole Pi has an angular width of 15°, and constitutes a north pole, while the adjacent poles Pa are of opposite polarity, namely south. Naturally, the polarity of the adjacent Pa and irregular Pi poles can be reversed.

As can be seen in greater detail in FIG. 3A, in the absence of the subject of the invention, each measuring element 2 delivers a raw signal, called the uncorrected signal Sb, that includes parts Sba and Sbi corresponding to the passages of the adjacent poles Pa and of an irregular pole Pi respectively. As can be seen in greater detail in FIG. 4A, and in the absence of the subject of the invention, the differential signal, known as the raw signal Sd between the two signals delivered by the measuring elements 2, includes parts Sda and Sdi corresponding to the passages of the adjacent poles Pa and the irregular pole Pi respectively. It should be noted that the part of the signal Sdi, located between the Sda parts, has a low slope, which leads to uncertainty regarding the position of the edge Si of the output signal Ss from the sensor, as illustrated in FIG. 5.

In order to overcome this drawback and according to the invention, each irregular pole Pi includes resources 10 for correcting the value of its magnetic field, so as to stabilize the differential signal Sd, in such a way that the part of the differential signal Sdic, obtained at the passage through zero, and located between the parts Sdac of the differential signal corresponding to the passages of the adjacent poles Pa, has a slope whose value, in absolute terms, is more-or-less identical to the values of the slopes of the parts of the differential signal obtained at the passage through zero, and corresponding to the passage of the other poles. It should be considered that the slope of the Sdic part of the differential signal is more-or-less identical to the slope of the Sdac parts of the differential signal corresponding to the passage of the adjacent poles and/or to the slope of the parts of the differential signal corresponding to the passage of at least some, and preferably of all, of the regular poles. According to one advantageous characteristic, the slope of the Sdic part of the differential signal is more-or-less identical to the slope of the parts of the differential signal corresponding to the passage of all of the poles N and S described as regular.

In the example illustrated in FIG. 4B, the part of the differential signal located between the parts Sdac of the differential signal corresponding to the passage of the adjacent poles Pa, has a rising part Sdic, while the parts Sdac, Sdc of the differential signal corresponding to the passage of the adjacent poles and of the other poles respectively, vary downwards. The slope of this rising part Sdic of the differential signal has a slope at the passage through zero gauss which, in absolute value, is more-or-less identical to the values of the slopes of the descending parts Sdac and/or Sdc of the differential signal obtained at the passage through zero gauss.

These resources 10 for correcting the value of the magnetic field of the irregular pole Pi are such that the slopes at the passage through zero, firstly, of the part Sdic of the differential signal located between the parts of the differential signal corresponding to the passage of the adjacent poles and, secondly, of the parts Sdac and/or Sdc of the differential signal corresponding to the passage of the adjacent poles and of the other poles, have a value that is more-or-less identical, greater than 30 gauss per degree for example, and preferably equal to or greater than 100 gauss per degree.

As can be seen from the preceding description, the rising edge Sdic of the differential signal, corresponding to the passage of the irregular pole Pi, has a stability of the same order as the falling edges of the other poles. Thus for a coding described as 60−1 tooth, it is possible to obtain 60 pulses for the output signal, corresponding to 59 falling edges and one rising edge corresponding to the part of the intermediate differential signal located between the two poles Pa adjacent to the irregular pole Pi. Such correction resources 10 thus allow the coding to be increased, while also preserving good accuracy of the measurements regarding the location of the irregular pole Pi.

The resources 10 for correcting the value of the irregular magnetic field take the form of a gradual magnetization of the irregular pole Pi, such that the raw signal, obtained by the passage of the irregular pole in front of the measuring element, varies symmetrically. Thus, as can be seen in greater detail in FIG. 3B, the signal obtained Sb includes a rising part Sbc and a decreasing part Sbd, separated by a linking part Sbl. According to one advantageous characteristic of the invention, this linking part Sbl has a width that is at least greater than the distance measured at the level of the measuring radius between the two measuring elements 2.

According to another advantageous characteristic of the illustrated implementation, the linking part of the raw signal Sbl has a shape, allowing for the gap distance that is identical to the parts of the signal corresponding to the regular pole, as can be seen clearly in FIG. 3B.

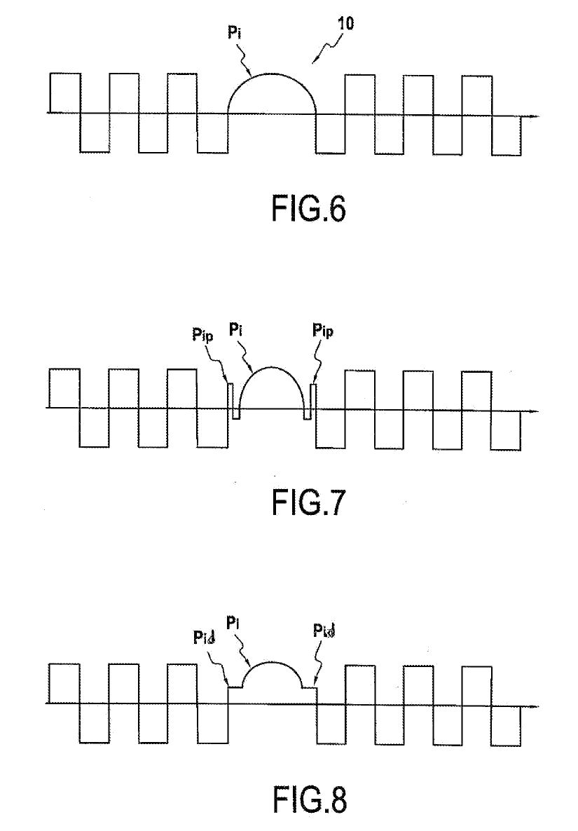

FIG. 6 illustrates an implementation example of the gradual magnetization of the irregular pole Pi, having a profile in the form of a curved arc that is circular or pseudo-circular. As illustrated in FIG. 7, the gradual magnetization of the irregular pole Pi has a profile with one part in the form of a circular arc, bordered on either side by a gap part arising from poles of opposite polarity Pip.

In the example illustrated in FIG. 8, the gradual magnetization of the irregular pole Pi has a profile with one part in a circular arc, bordered on either side by a magnetic gap part Pid.

What is claimed is:

1. A position sensor of the type which includes a coder (1) formed by a multi-pole magnetic ring that is equipped around its circumference with alternate north poles (N) and south poles (S), and mounted to pass in front of at least one pair of measuring elements (2), each delivering a periodic signal which firstly corresponds to changes in the strength of the magnetic field delivered by the poles, and secondly is used to obtain a differential signal between the said two signals, where at least one of the poles of opposite polarity to the polarity of its adjacent poles is said to be irregular (Pi) and has a different separation between its two adjacent poles (Pa) in relation to the separation pitch between the other poles, wherein the irregular pole (Pi) includes resources (10) for correcting the value of its magnetic field so as to stabilize the differential signal in such a way that the part (Sdic) of the differential signal taken at the passage through zero, and located between the parts (Sdac) of the differential signal corresponding to the passages of the adjacent poles (Pa), has a slope whose value, in absolute terms, is more-or-less identical to the values of the slopes of the parts of the differential signal obtained at the passage through zero and corresponding to the passages of the other poles.

2. A position sensor according to claim 1, wherein the resources (10) for correcting the value of the magnetic field of the irregular pole are designed, in more-or-less identical fashion, to stabilize the rising or falling edge obtained from the differential signal located between the falling or rising edges respectively obtained from the differential signal and corresponding to the passage from the adjacent poles to the irregular pole.

3. A position sensor according to claim 1, wherein the resources (10) for correcting the value of the magnetic field of the irregular pole are designed, in more-or-less identical manner, to stabilize the rising or falling edge obtained from the differential signal located between the falling or rising edges respectively obtained from the differential signal, and corresponding to the passage of all of the north (N) and south (S) poles.

4. A position sensor according to claim 1, wherein the resources (10) for correcting the value of the magnetic field of the irregular pole (Pi) are such that the slopes at the passage through zero, firstly of the part of the differential signal located between the parts of the differential signal corresponding to the passages of the adjacent poles, and secondly of the parts of the differential signal corresponding to the passages of the adjacent poles and of the other poles, have a value that is more-or-less identical and greater than 30 gauss per degree for example, and preferably greater than 100 gauss per degree.

5. A position sensor according to claim 1, wherein the resources (10) for correcting the value of the magnetic field of the irregular pole (Pi) take the form of a gradual magnetization, such that the raw signal obtained by the passage of the irregular pole in front of a measuring element, varies symmetrically.

6. A position sensor according to claim 5, wherein the raw signal (Sb), obtained by the passage of the irregular pole (Pi), includes a rising part (Sbc) and a falling part (Sbd), separated by a linking part (Sbl) whose width is at least greater than the distance obtained at the level of the measuring radius between the measuring elements (2).

7. A position sensor according to claim 6, wherein the linking part (Sbl) of the raw signal has a shape that is identical to the parts of the raw signal corresponding to the regular poles.

8. A position sensor according to claim 7, wherein the gradual magnetization of the irregular pole (Pi) has a profile of which at least one part is an arc of a curve.

9. A position sensor according to claim 8, wherein the gradual magnetization of the irregular pole (Pi) has a profile with one part in an arc of a curve, bordered on either side by a magnetic gap part (Pid).

10. A position sensor according to claim 8, wherein the gradual magnetization of the irregular pole (Pi) has a profile with one part in a circular arc, bordered on either side by poles of opposite polarity (Pip).

11. A position sensor according to claim 1, wherein the coder (1) is fixed in rotation on a rotating shaft of a motor vehicle.

12. A position sensor according to claim 11, wherein the coder (1) is mounted on the shaft of a motor-vehicle engine.

13. A position sensor according to claim 11, wherein the coder (1) is mounted on a transmission shaft of a motor vehicle.
